(19) United States
(12) Patent Application Publication
(10) Pub. No.: US 2010/0327725 A1
(43) Pub. Date: Dec. 30, 2010

(54) Light-Emitting Diode (LED) Lamp and Polygonal Heat-Dissipation Structure Thereof

(75) Inventors: Yen-Yu Huang, Taipei (TW); Yu-Yu Lin, Taipei (TW); Yu-Chun Lin, Taipei (TW); Huai-Jen Lu, Taipei (TW); Wan-Chih Lin, Taipei (TW)

Correspondence Address: REED SMITH LLP, Suite 1400, 3110 Fairview Park Drive, Falls Church, VA, 22042, US

(73) Assignee: Opto Tech Corporation, Hsinchu (TW)

(21) Appl. No.: 12/492,379

(22) Filed: Jun. 26, 2009

(51) Int. Cl. H01J 61/52

(52) U.S. Cl. 313/46

(57) ABSTRACT

A light-emitting diode (LED) lamp and a polygonal heat-dissipation structure thereof are provided. The LED lamp includes a polygonal heat-dissipation unit and a lighting module. The polygonal heat-dissipation unit has a polygonal hollow column and fins. The fins and the lighting module are thermally disposed on an inner surface and an outer surface of the polygonal hollow column, respectively. Thus, heat generated by the lighting module is dissipated by the fins rapidly. As the fins are thermally disposed on the inner surface of the polygon hollow column instead of being exposed, the volume of the LED lamp can be minimized, and the look of the LED lamp also can be prettified.

### BACKGROUND OF THE INVENTION

1. Technical Field

The present invention relates to light-emitting diode (LED) lamps and polygonal heat-dissipation structures thereof. More particularly, the present invention relates to an LED lamp configured for illumination and a polygonal heat-dissipation structure thereof.

2. Description of Related Art

With such advantages as high brightness, power saving, and long service life, light-emitting diodes (LEDs) are becoming more widely used in various lighting equipment and more versatile, as LEDs nowadays function as a light source for use in street lamps, vehicle lighting, billboards, landscaping, etc.

If heat generated by LEDs in operation is not efficiently dissipated, the quality of light emission by the LEDs will deteriorate, and the LEDs themselves will even be damaged and end up with a short service life. Hence, efficient heat dissipation is essential to quality light emission and a long service life as far as LEDs are concerned.

FIG. 1 is a schematic view of a conventional LED lamp having a heat-dissipation device. As shown in FIG. 1, an LED 212 is thermally disposed on fins 120 so as for heat generated by the LED 212 to be dissipated. Generally, the fins 120 are large enough to maximize area of heat dissipation and thereby enhance heat dissipation. In addition, the fins 120 are exposed from the LED lamp to maximize area of contact between the fins 120 and air and thereby increase the efficiency of heat dissipation.

However, the volume of the LED lamp is increased by the large and exposed fins 120. If it is desired to install plural sets of fins 120 in the same LED lamp, any effort to reduce the volume of the LED lamp will prove futile. Also, the LED lamp is rendered unsightly by the fins 120 exposed therefrom, thus limiting the application of the LED lamp.

### BRIEF SUMMARY OF THE INVENTION

It is an objective of the present invention to provide a light-emitting diode (LED) lamp and a polygonal heat-dissipation structure thereof, wherein fins are disposed inside a polygonal hollow column rather than exposed from the LED lamp, thereby prettifying the look of the LED lamp.

Another objective of the present invention is to provide an LED lamp and a polygonal heat-dissipation structure thereof, wherein fins are disposed on an inner surface of a polygonal hollow column, thereby making efficient use of the space inside the LED lamp and reducing the volume of the LED lamp.

Yet another objective of the present invention is to provide an LED lamp and a polygonal heat-dissipation structure thereof, wherein openings are provided at two ends of a polygonal hollow column, respectively, to enable air circulation for removing heat quickly from fins provided inside the polygonal hollow column.

A further objective of the present invention is to provide an LED lamp and a polygonal heat-dissipation structure thereof, wherein a reflecting element is placed in a light path of every LED, thereby allowing configuration of light emitted by the LED lamp to vary as needed by adjusting an angle of reflection of the reflecting element.

To achieve the above and other objectives, the present invention provides an LED lamp including a polygonal heat-dissipation unit and a plurality of lighting modules. The polygonal heat-dissipation unit includes a polygonal hollow column and a plurality of fins, wherein the polygonal hollow column has two ends provided with a first opening and a second opening, respectively, and the polygonal hollow column further has an outer surface and an inner surface while the fins are thermally disposed on the inner surface of the polygonal hollow column. The lighting modules are disposed on the outer surface of the polygonal hollow column successively and each include: a light-emitting unit including a circuit board and a plurality of LEDs, the circuit board being thermally disposed on the outer surface of the polygonal hollow column, and the LEDs being electrically connected to and provided on the circuit board; a first reflecting element having a first reflecting surface placed in light paths of the LEDs of the light-emitting unit; and a second reflecting element having a second reflecting surface placed in a light path of light reflected off the first reflecting element.

To achieve the above and other objectives, the present invention further provides a polygonal heat-dissipation structure for use with an LED lamp, wherein the polygonal heat-dissipation structure includes a polygonal hollow column and a plurality of fins. The polygonal hollow column has two ends provided with a first opening and a second opening, respectively. The polygonal hollow column further has an outer surface and an inner surface. The fins are thermally disposed on the inner surface of the polygonal hollow column.

Implementation of the present invention at least brings about the following inventive effects:

1. The look of an LED lamp is prettified by disposing fins inside the LED lamp;

2. The volume of the LED lamp is reduced by disposing the fins on an inner surface of a polygonal hollow column; and

3. The configuration of light emitted by the LED lamp can be varied by means of reflecting elements provided on the polygonal hollow column, so as to broaden application of the LED lamp.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawings, wherein:

FIG. 1 is a schematic view of a conventional LED lamp having a heat-dissipation device;

FIG. 2 is an exploded perspective view of an embodiment of an LED lamp according to the present invention;

FIG. 3 is a perspective view of the embodiment of the LED lamp shown in FIG. 2 when assembled;

FIG. 4A is a cross-sectional view of a first reflecting element according to the present invention;

FIG. 4B is a cross-sectional view of a second reflecting element according to the present invention;

FIG. 4C is a cross-sectional view of a third reflecting element according to the present invention;

FIG. 5 is a cross-sectional view taken along line A-A of FIG. 3;

FIG. 6 is an exploded perspective view of another embodiment of the LED lamp according to the present invention;

FIG. 7 is a perspective view of yet another embodiment of the LED lamp according to the present invention; and

FIG. 8 is a perspective view of still another embodiment of the LED lamp according to the present invention.

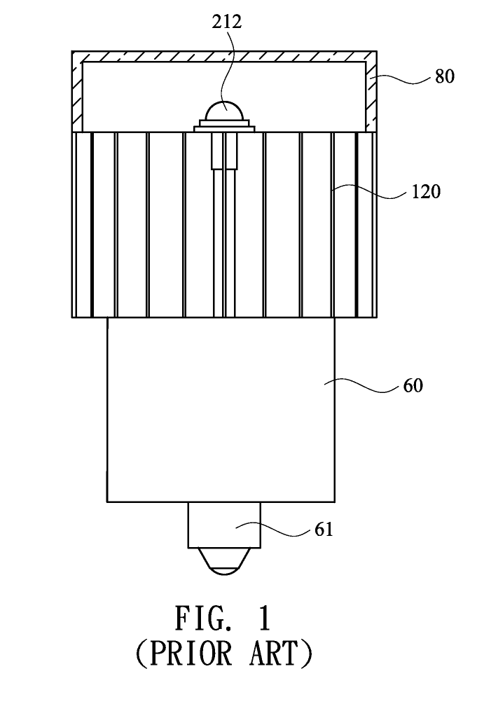

### DETAILED DESCRIPTION OF THE INVENTION

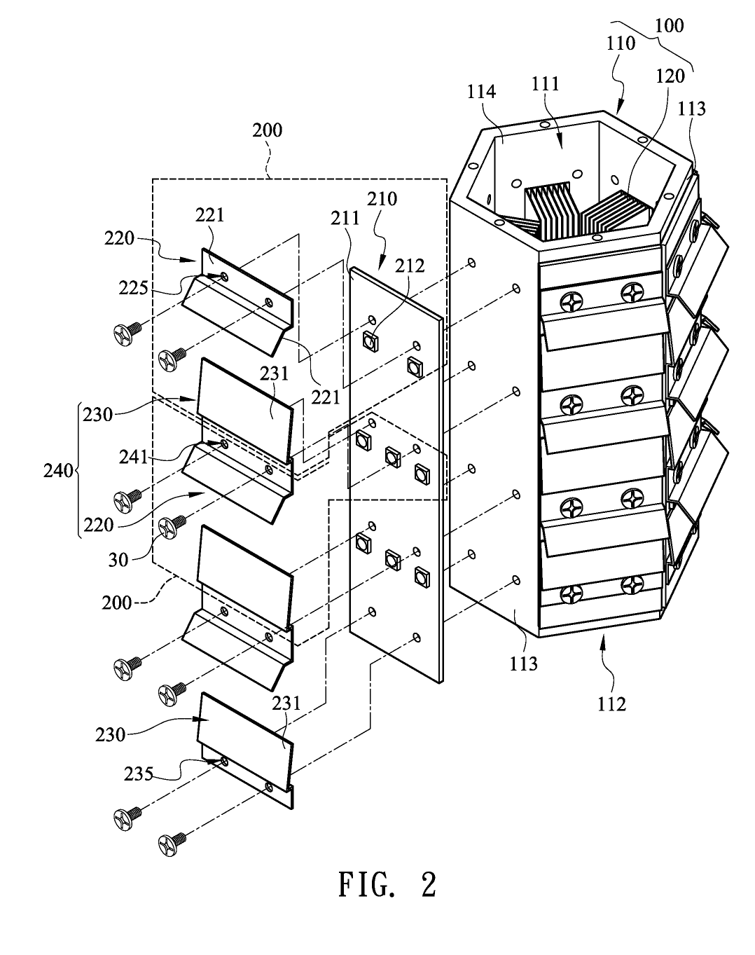

Referring to FIG. 2, in an embodiment, a light-emitting diode (LED) lamp of the present invention includes a polygonal heat-dissipation unit 100 and a plurality of lighting modules 200.

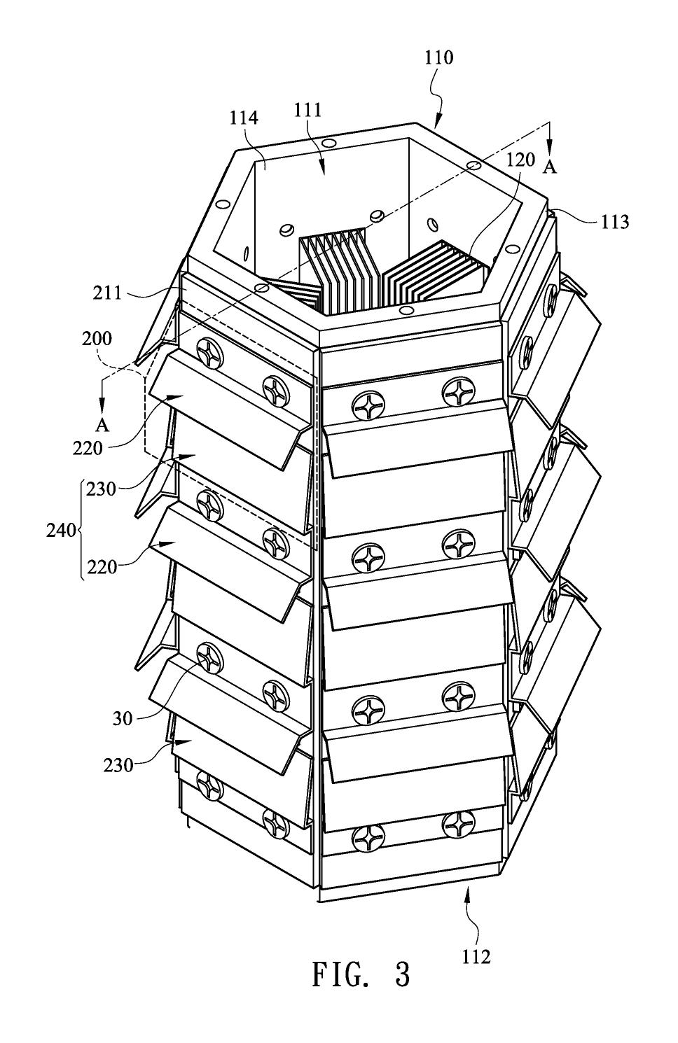

Referring to FIG. 2 and FIG. 3, the polygonal heat-dissipation unit 100 includes a polygonal hollow column 110 and a plurality of fins 120. A first opening 111 and a second opening 112 are provided at two ends of the polygonal hollow column 110, respectively. Hence, the first opening 111 and the second opening 112 communicate with each other to enable air circulation. The polygonal hollow column 110 further has an outer surface 113 and an inner surface 114. The fins 120 are thermally disposed on the inner surface 114 of the polygonal hollow column 110. The polygonal hollow column 110 and the fins 120 together form a one-piece unit.

With the polygonal heat-dissipation unit 100 being conducive to air circulation, the fins 120 thermally disposed on the inner surface 114 of the polygonal hollow column 110 remove heat quickly by means of air so as to speed up heat dissipation. In addition, with the fins 120 being thermally disposed on the inner surface 114 of the polygonal hollow column 110, the volume of the LED lamp can be minimized.

Referring to FIG. 2 and FIG. 3, the lighting modules 200 are disposed on the outer surface 113 of the polygonal hollow column 110 successively. Each of the lighting modules 200 includes a light-emitting unit 210, a first reflecting element 220, and a second reflecting element 230, wherein the light-emitting unit 210, the first reflecting element 220, and the second reflecting element 230 are each screwed to the outer surface 113 of the polygonal hollow column 110 by at least two screws 30.

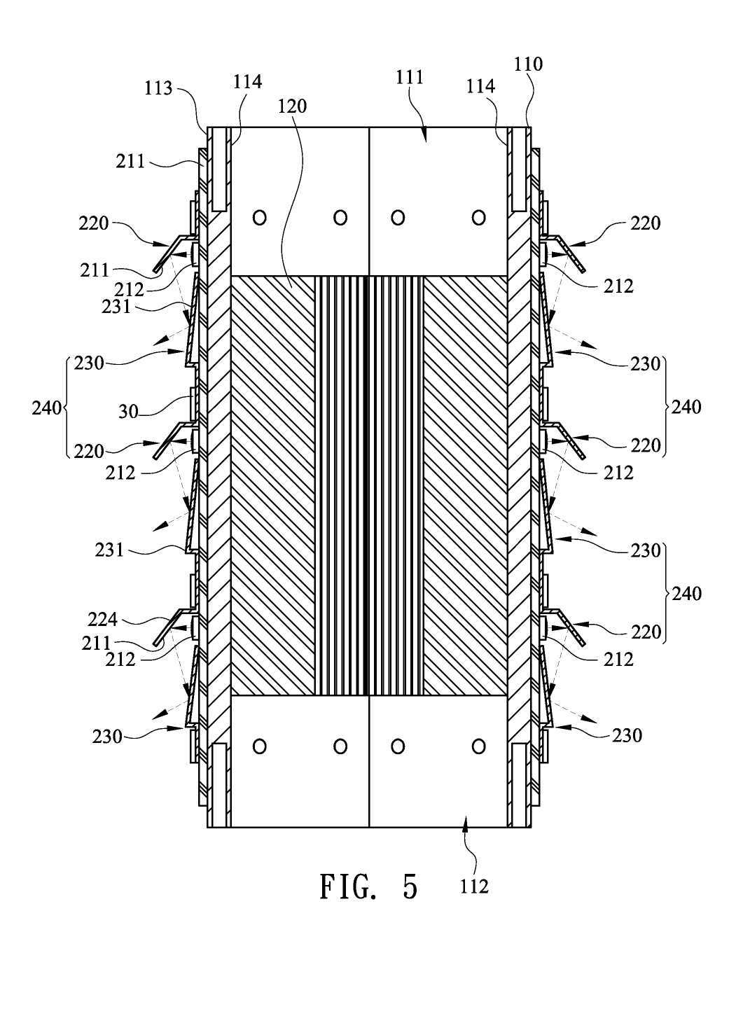

Referring to FIG. 2 and FIG. 3, the light-emitting unit 210 includes a circuit board 211 and a plurality of LEDs 212. The circuit board 211 is thermally disposed on the outer surface 113 of the polygonal hollow column 110; hence, heat generated by the circuit board 211 is transferred to the fins 120 thermally disposed on the inner surface 114 of the polygonal hollow column 110 via the polygonal hollow column 110 (as shown more clearly in FIG. 5).

With the LEDs 212 being electrically connected to and provided on the circuit board 211, heat generated by the LEDs 212 is transferred to the fins 120 via the circuit board 211 and thereby dissipated. With air circulating inside the polygonal hollow column 110, the heat transferred to the fins 120 is quickly removed by air. Hence, the LEDs 212 operate at appropriate temperature, and the quality of light emission is enhanced.

To allow heat generated by the LEDs 212 during light emission to be quickly transferred to the inner surface 114 of the polygonal hollow column 110 via the circuit board 211, the circuit board 211 is made of a material having high thermal conductivity, such as a copper circuit substrate, an aluminum circuit substrate, or a graphite circuit substrate.

Referring to FIG. 2 and FIG. 3, the first reflecting element 220 of each of the lighting modules 200 has a first reflecting surface 221, and the first reflecting surface 221 is placed in light paths of corresponding ones of the LEDs 212 (as shown more clearly in FIG. 5). The second reflecting element 230 of each of the lighting modules 200 has a second reflecting surface 231, and the second reflecting surface 231 is placed in a light path of light reflected off a corresponding one of the first reflecting elements 220; in other words, in every occurrence of light emission of the LEDs 212, the emitted light is reflected off the corresponding first reflecting surface 221 and the corresponding second reflecting surface 231 in sequence (as shown in FIG. 5). Hence, by adjusting an angle of reflection of the first reflecting element 220 and the second reflecting element 230, the outgoing direction of light from the LEDs 212 is varied, and the configuration of light emitted by the LED lamp is varied accordingly.

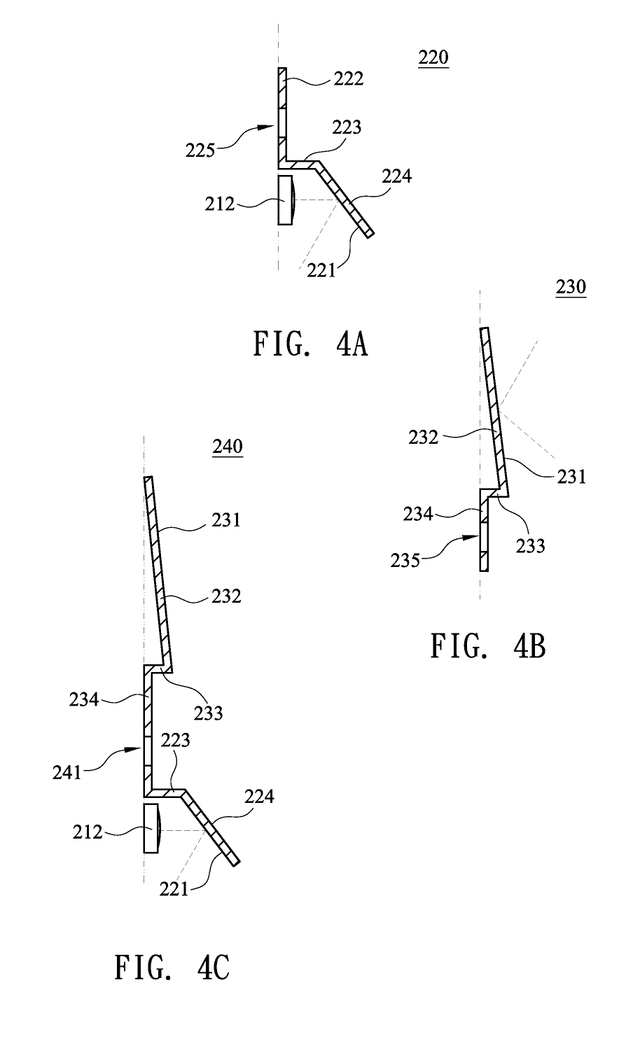

Referring to FIG. 4A, the first reflecting element 220 of each of the lighting modules 200 is formed by bending a plate to provide a first plate 222, a first connecting plate 223, and a first oblique plate 224. The first plate 222 has at least two first through-holes 225 for penetration by the screws 30. The first reflecting element 220 is fixed in position to the outer surface 113 of the polygonal hollow column 110 by passing the screws 30 through the first through-holes 225 (as shown in FIG. 2). The first oblique plate 224 has the first reflecting surface 221. The first reflecting surface 221 of the first oblique plate 224 is placed in light paths of corresponding ones of the LEDs 212 so as for light emitted by the corresponding ones of the LEDs 212 to be reflected by the first reflecting surface 221.

Referring to FIG. 4B, the second reflecting element 230 of each of the lighting modules 200 is also formed by bending a plate to provide a second oblique plate 232, a second connecting plate 233, and a second plate 234. The second plate 234 has at least two second through-holes 235 for penetration by the screws 30. The second reflecting element 230 is fixed in position to the outer surface 113 of the polygonal hollow column 110 by passing the screws 30 through the second through-holes 235 (as shown in FIG. 2). The second oblique plate 232 has the second reflecting surface 231. The second reflecting surface 231 of the second oblique plate 232 is placed in a light path of light reflected from the corresponding first oblique plate 224 so as to reflect light reflected off the corresponding first reflecting surface 221 (as shown in FIG. 5).

Referring to FIG. 2, the second reflecting element 230 and the first reflecting element 220 between each two adjacent ones of the lighting modules 200 are integrally formed as a third reflecting element 240. Referring to FIG. 4C, the third reflecting element 240 is also formed by bending a plate to provide the second oblique plate 232, the second connecting plate 233, the second plate 234, the first connecting plate 223, and the first oblique plate 224. The second plate 234 has at least two third through-holes 241 for penetration by the screws 30. The third reflecting element 240 is fixed in position to the outer surface 113 of the polygonal hollow column 110 by passing the screws 30 through the third through-holes 241 (as shown in FIG. 2).

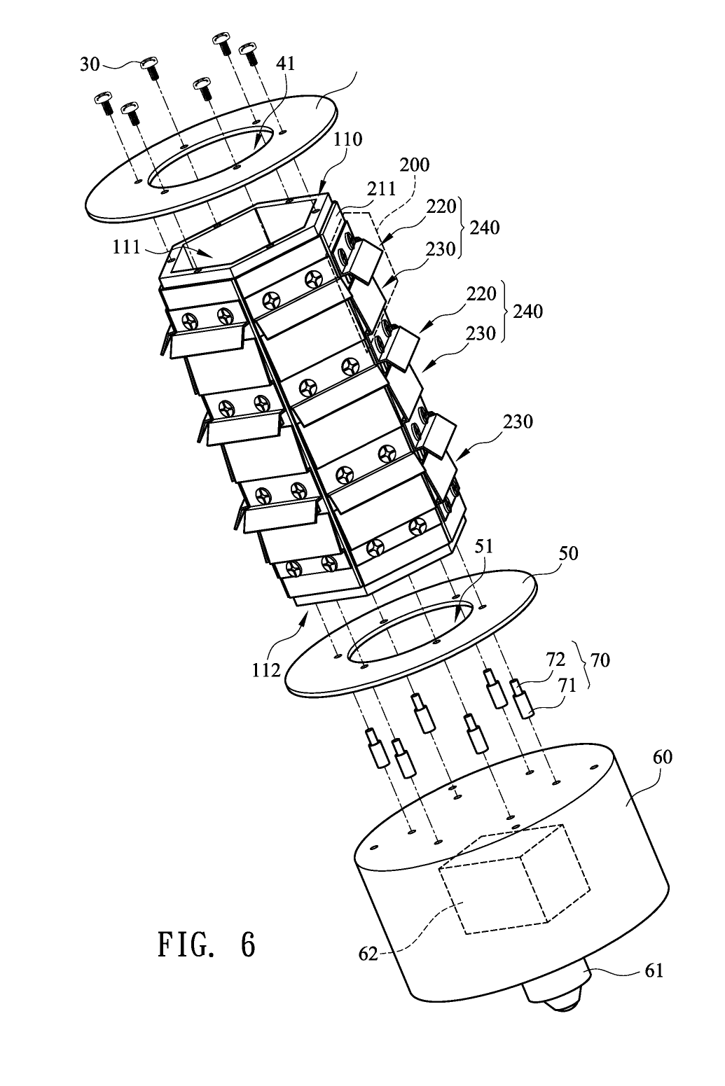

Referring to FIG. 6, the LED lamp further includes a cover plate 40. The cover plate 40 corresponds in position to the first opening 111 of the polygonal hollow column 110 so as to render the LED lamp visually appealing. The cover plate 40 has a first aperture 41 in communication with the first opening 111.

Referring to FIG. 6, the LED lamp further includes a supporting plate 50. The supporting plate 50 corresponds in position to the second opening 112 of the polygonal hollow column 110. The supporting plate 50 has a second aperture 51 in communication with the second opening 112. Hence, air circulates through the polygonal hollow column 110 by means of the second aperture 51 of the supporting plate 50 and the first aperture 41 of the cover plate 40.

Referring to FIG. 6, the LED lamp further includes a lamp stand 60 and at least a supporting element 70. The lamp stand 60 is provided with a power terminal 61. The lamp stand 60 is provided with a power unit 62 therein. The power unit 62 is electrically connected to the power terminal 61 and to the circuit board 211 of each of the light-emitting units 210 so as to convert alternating current (AC) to direct current (DC) for driving the LEDs 212 of each of the light-emitting units 210. Hence, the LED lamp can be directly connected to a power terminal of a lamp stand for access to AC power. The power terminal 61 is an E27 power terminal or an E40 power terminal so as for the LED lamp to be applicable to a household electric appliance, such as a desk lamp, a wall lamp, and so on.

Referring to FIG. 6, each of the at least a supporting element 70 has a first end portion 71 and a second end portion 72. The first end portion 71 is coupled to the lamp stand 60. The second end portion 72 is coupled to the supporting plate 50 of the LED lamp. The at least a supporting element 70 is positioned proximate to the second opening 112 of the polygonal hollow column 110. The at least a supporting element 70 spaces apart the lamp stand 60 and the supporting plate 50 so as for air to pass through the second aperture 51 of the supporting plate 50 to enable air circulation.

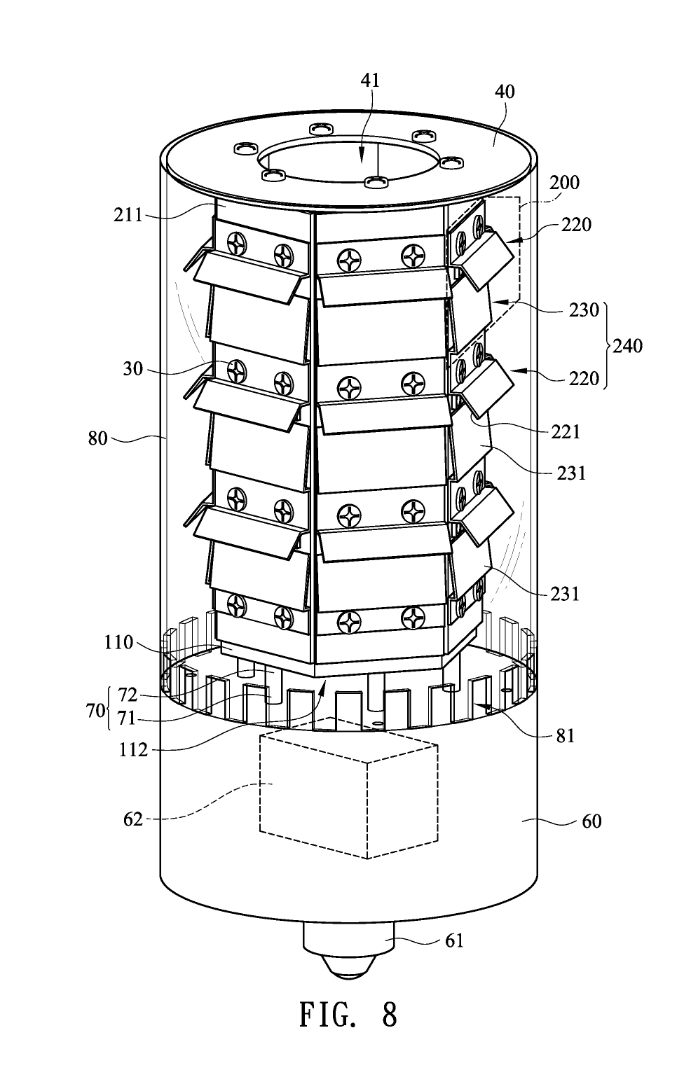

Referring to FIG. 8, the first end portion 71 of each of the at least a supporting element 70 is directly coupled to the lamp stand 60 while the second end portion 72 of each of the at least a supporting element 70 is coupled to the polygonal hollow column 110 itself. Likewise, the at least a supporting element 70 is positioned proximate to the second opening 112 of the polygonal hollow column 110.

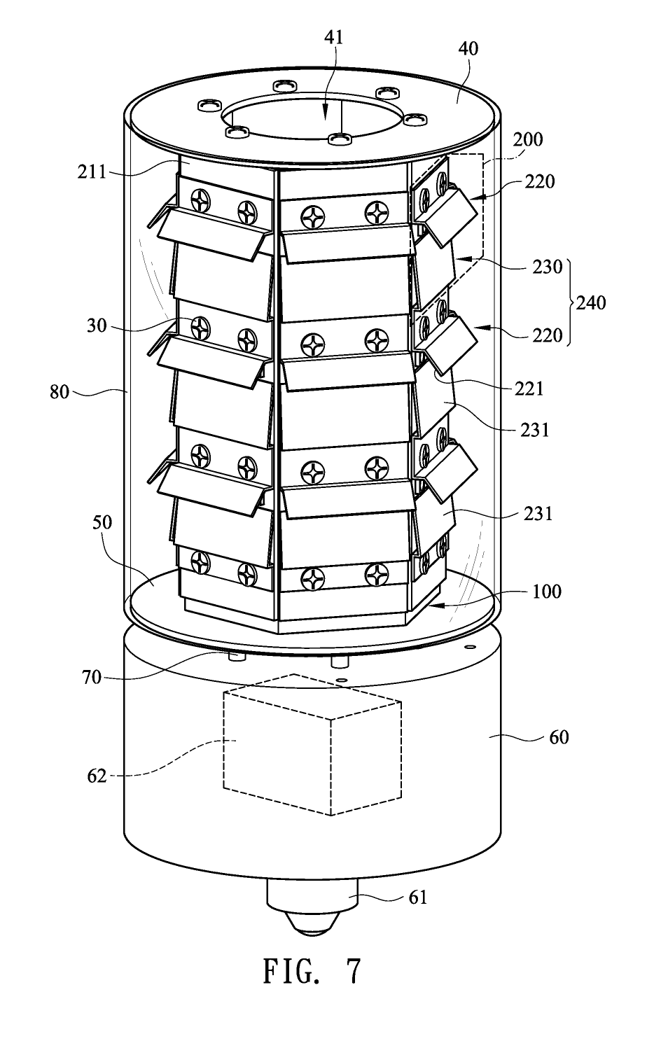

Referring to FIG. 7, the LED lamp further includes a lampshade 80. Two ends of the lampshade 80 are coupled to the cover plate 40 and the supporting plate 50, respectively, such that the polygonal heat-dissipation unit 100 is enclosed by the lampshade 80 and protected from inadvertent impact and moisture.

Referring to FIG. 8, alternatively, the lampshade 80 is coupled to the lamp stand 60, and a plurality of slits 81 are formed at the lamp-stand-coupled end of the lampshade 80. Thus, air passes through the slits 81 and the second opening 112 of the polygonal hollow column 110 to facilitate air circulation in the polygonal hollow column 110.

The foregoing preferred embodiments are illustrative of the characteristics of the present invention so as to enable a person skilled in the art to gain insight into the disclosure of the present invention and be capable of implementing the present invention accordingly, but are not intended to restrict the scope of the present invention. Hence, all equivalent modifications and variations made in the foregoing preferred embodiments without departing from the spirit and principle of the present invention should fall within the scope of the appended claims.

What is claimed is:

1. A light-emitting diode (LED) lamp, comprising:
a polygonal heat-dissipation unit comprising:
a polygonal hollow column having two ends provided with a first opening and a second opening, respectively, the polygonal hollow column further having an outer surface and an inner surface; and
a plurality of fins thermally disposed on the inner surface of the polygonal hollow column; and
a plurality of lighting modules disposed on the outer surface of the polygonal hollow column successively and each comprising:
a light-emitting unit comprising a circuit board and a plurality of LEDs, the circuit board being thermally disposed on the outer surface of the polygonal hollow column, and the LEDs being electrically connected to and provided on the circuit board;
a first reflecting element having a first reflecting surface placed in light paths of the LEDs of the light-emitting unit; and
a second reflecting element having a second reflecting surface placed in a light path of light reflected off the first reflecting element.

2. The LED lamp of claim 1, wherein the polygonal hollow column and the fins together form a one-piece unit.

3. The LED lamp of claim 1, wherein each said light-emitting unit, as well as each said first reflecting element and each said second reflecting element, is screwed to the outer surface of the polygonal hollow column by at least two screws.

4. The LED lamp of claim 1, wherein each said first reflecting element is formed by bending a plate to provide a first plate, a first connecting plate, and a first oblique plate, the first plate having at least two first through-holes, and the first oblique plate having the first reflecting surface.

5. The LED lamp of claim 1, wherein each said second reflecting element is formed by bending a plate to provide a second oblique plate, a second connecting plate, and a second plate, the second plate having at least two second through-holes, and the second oblique plate having the second reflecting surface.

6. The LED lamp of claim 1, wherein the second reflecting element and the first reflecting element between each two adjacent said lighting modules are integrally formed as a third reflecting element.

7. The LED lamp of claim 6, wherein each said third reflecting element is formed by bending a plate to provide the second oblique plate, the second connecting plate, the second plate, the first connecting plate, and the first oblique plate, the second plate having at least two third through-holes, the second oblique plate having the second reflecting surface, and the first oblique plate having the first reflecting surface.

8. The LED lamp of claim 1, further comprising a cover plate corresponding in position to the first opening and having a first aperture in communication with the first opening.

9. The LED lamp of claim 1, further comprising a supporting plate corresponding in position to the second opening and having a second aperture in communication with the second opening.

10. The LED lamp of claim 9, further comprising a lamp stand provided with a power terminal and at least a supporting element having a first end portion coupled to the lamp stand and a second end portion coupled to the supporting plate, wherein the at least a supporting element is positioned proximate to the second opening.

11. The LED lamp of claim 10, wherein the lamp stand is provided with a power unit electrically connected to the power terminal and each said circuit board so as to convert alternating current (AC) to direct current (DC) for driving the LEDs.

12. The LED lamp of claim 10, wherein the power terminal is an E27 power terminal or an E40 power terminal.

13. The LED lamp of claim 10, further comprising a lampshade coupled to the lamp stand such that the polygonal heat-dissipation unit is enclosed by the lampshade.

14. The LED lamp of claim 1, further comprising a lamp stand and at least a supporting element, the lamp stand being provided with a power terminal, and each of the at least a supporting element having a first end portion coupled to the lamp stand and a second end portion coupled to the polygonal hollow column, wherein the at least a supporting element is positioned proximate to the second opening.

15. The LED lamp of claim 14, wherein the lamp stand is provided with a power unit electrically connected to the power terminal and each said circuit board so as to convert alternating current (AC) to direct current (DC) for driving the LEDs.

16. The LED lamp of claim 14, wherein the power terminal is an E27 power terminal or an E40 power terminal.

17. The LED lamp of claim 14, further comprising a lampshade coupled to the lamp stand such that the polygonal heat-dissipation unit is enclosed by the lampshade.

18. A polygonal heat-dissipation structure for use with a light-emitting diode (LED) lamp, comprising:
a polygonal hollow column having two ends provided with a first opening and a second opening, respectively, the polygonal hollow column further having an outer surface and an inner surface; and
a plurality of fins thermally disposed on the inner surface of the polygonal hollow column.

19. The polygonal heat-dissipation structure of claim 18, wherein the polygonal hollow column and the fins together form a one-piece unit.

20. The polygonal heat-dissipation structure of claim 18, further comprising a cover plate corresponding in position to the first opening and having a first aperture in communication with the first opening.

21. The polygonal heat-dissipation structure of claim 18, further comprising a supporting plate corresponding in position to the second opening and having a second aperture in communication with the second opening.
